(19) United States
(12) Patent Application Publication
(10) Pub. No.: US 2006/0082996 A1
(43) Pub. Date: Apr. 20, 2006

(54) Lamp

(76) Inventor: Steve Lee, Park Ridge, IL (US)

Correspondence Address: Douglas H. Pauley;Pauley Petersen & Erickson, Suite 365, 2800 West Higgins Road, Hoffman Estates, IL, 60195, US

(21) Appl. No.: 10/969,781

(22) Filed: Oct. 20, 2004

(51) Int. Cl. F21V 33/00

(52) U.S. Cl. 362/234

(57) ABSTRACT

A lamp including a base, a first light source including a first tube forming a first gas storage chamber containing a supply of a first gas, and a second light source including a second tube forming a second gas storage chamber containing a supply of a second gas. The first light source is normally electrically connected to the second light source, and each of the first gas and the second gas electrically actuatable to produce light.

### BACKGROUND OF THE INVENTION

1. Field of the Invention

This invention generally relates to a lamp. More specifically, this invention relates to a decorative lamp having a plurality of light sources mounted with respect to a base of the lamp, each light source containing a supply of gas to produce light of a desired color or various colors.

2. Discussion of Related Art

Many conventional lamps include an incandescent light bulb which emits or provides light during lamp operation. Such incandescent light bulbs require a significant amount of energy, produce a significant amount of heat during operation, and may provide light for only a limited life period.

There is a need for a decorative lamp capable of producing aesthetically pleasing light for an extended time period without requiring a significant amount of energy and/or producing a significant amount of heat during operation.

### SUMMARY OF THE INVENTION

It is one object of this invention to provide a lamp having a combination of light sources preferably emitting light of various or different colors to create a desired aesthetic result.

It is another object of this invention to provide a lamp having light sources each designed to have any shape, size, configuration or design, such that light source forms an aesthetic and/or desired visual effect with the remaining elements of the lamp.

It is yet another object of this invention to provide a lamp having a plurality of independently operable light sources.

The above and/or other objects of this invention are accomplished with a lamp including a base that provides support for the remaining components of the lamp and functions as a point of attachment for at least one light source. The base may be of any size, shape, configuration and/or design.

Preferably, a plurality of light sources are mounted or positioned with respect to the base. In one preferred embodiment of this invention, the lamp includes at least one first light source mounted with respect to the base. The first light source includes a tube forming a gas storage chamber containing a supply of a first gas, such as a supply of neon gas. At least one second light source is also mounted with respect to the base, and normally electrically connected to the first light source. The second light source includes a tube forming a gas storage chamber containing a supply of a second gas, such as a supply of xenon gas. The first gas and second gas may include any suitable gas, for example a suitable noble gas such as neon, argon, xenon, krypton or combinations of suitable gases and/or phosphors which are electrically actuatable or energizable to produce light of a desired color or colors.

In one preferred embodiment of this invention, a lead wire normally provides electrical communication between the first light source and the second light source. For example, the lead wire may be removably connectable to an electric contact, such as an electrode, positioned on a first portion of the first light source and/or removably connectable to an electric contact, such as an electrode, positioned at a first end portion of the second light source. When the lead wire is disconnected from the first light source electric contact and/or the second light source electric contact, the second light source is operable to produce light while the first light source will not operate. As a result of the open circuit, the second gas is electrically actuatable or energizable to produce light, but the first gas is not electrically actuatable or energizable and, thus, is at a static state or condition.

In one preferred embodiment of this invention, the first light source and the second light source are in electric communication, through an electrical wire, with an external power source, such as a household level of an electric voltage supply. In another preferred embodiment of this invention, the light sources are powered by an internal power source, such as a battery. Alternatively, the light source may be independently powered by a dedicated driver, such as a transformer that supplies power to a corresponding light source. For example, a first driver can supply electrical energy to the first light source, and a second driver can supply electrical energy to the second light source.

In certain preferred embodiments of this invention, ionization of at least one gas stored or contained within a gas storage chamber may be frequency dependent and, thus, require a power source or driver that provides power at a suitable or determined frequency or within a suitable or determined frequency range in order for the light source to function or operate properly. In such embodiments, one driver may supply suitable power to each light source. Alternatively, one dedicated driver can provide suitable power to the corresponding light source requiring the frequency dependent power, and a second independent driver can supply power to the remaining light source or light sources.

For example, a light source having a gas storage chamber containing a supply of xenon gas may require power at a determined frequency in order to ionize the xenon gas to produce light. A second light source may have a gas storage chamber containing a supply of neon gas, which may not require power supplied at a determined frequency or frequency range to ionize the neon gas to produce light. In one embodiment of this invention, one power source, such as a driver, can be connected to each light source at a determined frequency required by the light source containing xenon gas to produce light. Alternatively, a dedicated power source may supply power at the determined frequency to the light source containing the xenon gas, and an independent second power source may supply power to the light source containing the neon gas.

### BRIEF DESCRIPTION OF THE DRAWINGS

The above and other features of this invention can be understood when the specification is read in view of the following drawings, wherein:

FIG. 1 is a perspective front view of a lamp according to one preferred embodiment of this invention; and

FIG. 2 is a schematic circuit diagram of the lamp shown in FIG. 1.

It should be understood that the drawings are of preferred embodiments, and that there may be other embodiments of this invention. Therefore, it should be understood that the drawings are not intended to limit the scope of this invention, but that the scope of this invention be defined by the claims that follow the description of preferred embodiments.

### DESCRIPTION OF PREFERRED EMBODIMENTS

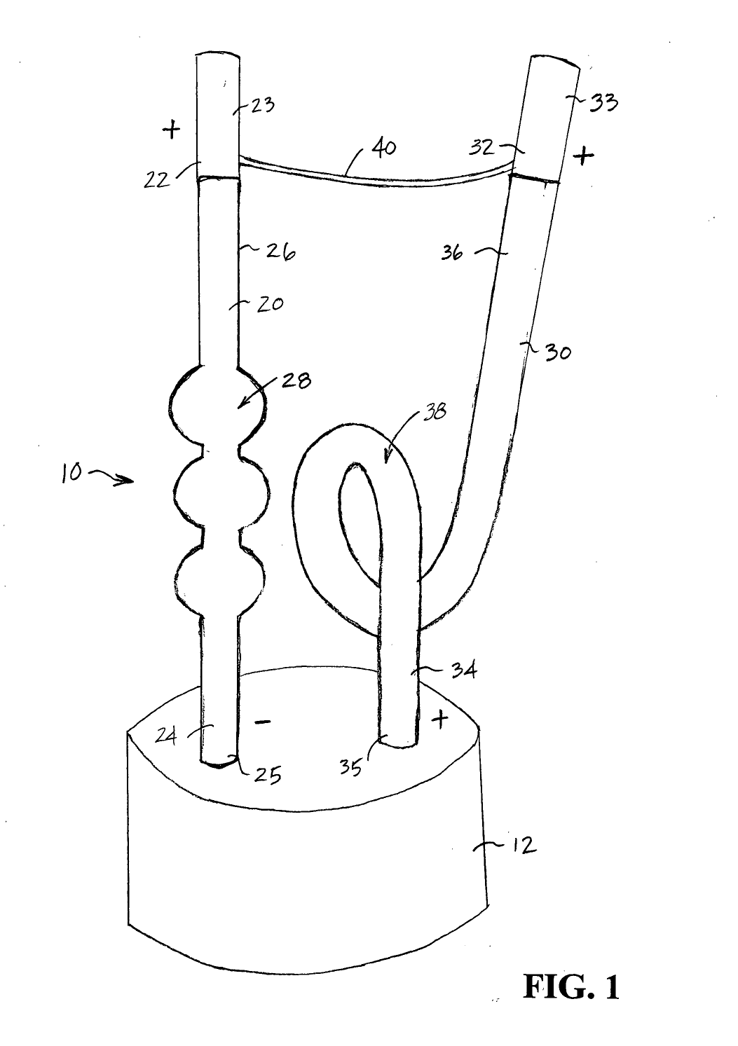

The present invention is directed to a lamp including a plurality of light sources that can be activated independently or in series. Referring to FIG. 1, in one preferred embodiment of this invention, a lamp 10 includes a base 12, a first light source 20, and a second light source 30 normally electrically connected to first light source 20. Lamp 10 can include any desirable number of first light sources 20 and/or second light sources 30. First light source 20 and/or second light source 30 can emit light of any desired color or any desired combination of colors. A combination of light sources 20, 30 emitting different colors may be used to create a desired aesthetic result. Further, light sources 20, 30 can be designed to have any shape, size, configuration and/or design. Light sources 20, 30 can form an aesthetic and/or desired visual effect with the remaining elements of lamp 10.

In one preferred embodiment of this invention, first light source 20 and second light source 30 are in electric communication, through an electrical wire, with an external power source, such as an electric voltage supply operating at a household level. In another preferred embodiment of this invention, light sources 20, 30 are powered by an internal power source, such as a battery. Alternatively, light sources 20, 30 may be powered by any other power source known to those skilled in the art.

Base 12 provides support for the remaining components of lamp 10 and functions as a point of attachment for first light source 20 and second light source 30. Base 12 may be of any size, shape, configuration and/or design. Further, base 12 may be a separate structure designed specifically for the purpose of functioning as a base for lamp 10. Base 12 may be formed of wood, plastic, metal or any other suitable material or materials known to those having ordinary skill in the art.

Base 12 preferably functions as a point of attachment for each light source. First light source 20 has a first end portion 22 forming a positive contact 23, and a second end or base portion 24 forming a negative contact 25. Base portion 24 is preferably mounted with respect to base 12. First light source 20 can be mounted with respect to base 12 using any method of attachment known to those having ordinary skill in the art. Alternatively, base portion 24 can be integrated with base 12 to form a continuous structure.

Second light source 30 has a first end portion 32 forming a first positive contact 33, and a second end or base portion 34 forming a second positive contact 35. Base portion 34 is preferably mounted with respect to base 12. Second light source 30 can be mounted with respect to base 12 using any method of attachment known to those skilled in the art. Alternatively, base portion 34 can be integrated with base 12 to form a continuous structure.

U.S. Pat. No. 6,247,829, including all of its teachings, is incorporated into this specification. First light source 20 and/or second light source 30 can be attached with respect to base 12, as taught by U.S. Pat. No. 6,247,829.

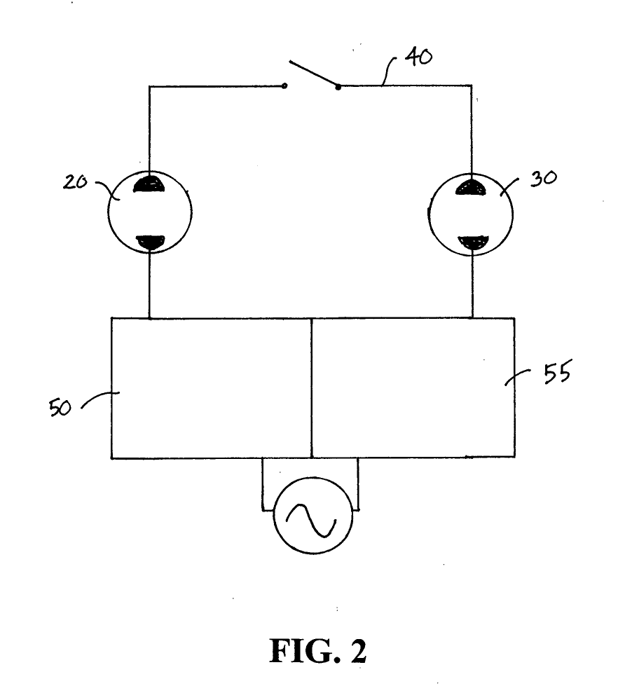

FIG. 2 schematically diagrams the electric circuit of lamp 10 according to one preferred embodiment of this invention. Components will be discussed with respect to specific functional tasks or task groupings that are in some cases arbitrarily assigned to the specific components for explanatory purposes. It will be appreciated by those having ordinary skill in the art that a lamp according to the present invention may be arranged in a variety of ways, or that functional tasks may be grouped according to other nomenclature or architecture while still accomplishing results of the present invention. Referring further to FIG. 2, first light source 20 is preferably electrically connected to second light source 30. For example, base portion 24 of first light source 20 is electrically connected to base portion 34 of second light source 30. Additionally, in one preferred embodiment of this invention, a lead wire 40 normally electrically connects or provides electrical communication between first light source 20 and second light source 30. As shown in FIG. 1, for example, lead wire 40 is preferably removably connectable, and may include a switch, between first end portion 22 of first light source 20 and first end portion 32 of second light source 30. More specifically, lead wire 40 normally connects positive contact 23 of first light source 20 with first positive contact 33 of second light source 30.

In one preferred embodiment of this invention, first light source 20 includes a first tube 26 which forms or defines a first gas storage chamber 28 containing a supply of a first gas. Similarly, second light source 30 preferably includes a second tube 36 forming a second gas storage chamber 38 containing a supply of a second gas. The terms “first gas” and “second gas” as used throughout this specification and in the claims can include one gas, a combination of gases, or a combination of a gas or gases with additives or other materials, such as phosphors, to produce light of a desired color or various desired colors, within first gas storage chamber 28 and/or second gas storage chamber 38. Thus, light of varying colors can be emitted by first light source 20 and/or second light source 30, depending upon the gas components contained within first gas storage chamber 28 and gas storage chamber 38, respectively.

First tube 26 and/or second tube 36 can be formed into a variety of different shapes and/or designs to form pleasing and/or desired aesthetics with the remaining elements of lamp 10. Lamp 10 may also include more than one first light source 20 and/or second light source 30, or a third light source different from first light source 20 and second light source 30.

Each of the first gas and the second gas is electrically actuatable or energizable to produce light. In one preferred embodiment of this invention wherein the first gas and/or the second gas includes a noble gas, such as neon and xenon, as electricity passes through first tube 26 and/or second tube 36, the gas contained within the tube is ionized, which produces a glow of light. Preferably but not necessarily, the first gas is different from the second gas to produce various colors or shades of color light. For example, in one preferred embodiment of this invention, the first gas comprises neon gas and the second gas comprises xenon gas. The first gas and the second gas may comprise other suitable gases including other noble gases, such as argon, and a combination of gases and/or phosphors to produce various colors and/or color shades. In another embodiment of this invention, the second gas can be the same or similar to the first gas.

As discussed above, in one preferred embodiment of this invention, lead wire 40 is removably connectable between first end portion 22 of first light source 20 and first end portion 32 of second light source 30. Preferably, when lead wire 40 is disconnected from positive contact 23 and/or first positive contact 33, the electric circuit of lamp 10, as shown schematically in FIG. 2, is open. As a result of the open circuit, the second gas contained within second tube 38 is electrically actuatable or energizable to produce light, but the first gas is not electrically actuatable or energizable, or is at a static state or condition. Thus, lead wire 40 can act as or include a switch, as shown in FIG. 2, that opens and closes the electric circuit, as desired.

In one preferred embodiment of this invention, first light source 20 and second light source 30 are independently powered by a dedicated driver, such as a transformer that supplies power to the corresponding light source. For example, a first driver 50 supplies electrical energy to first light source 20, and a second driver 55 supplies electrical energy to second light source 30.

In certain preferred embodiments of this invention, ionization of at least one gas stored or contained within a gas storage chamber may be frequency dependent and, thus, require a power source or driver that provides electric power at a suitable or determined frequency or within a suitable or determined frequency range in order for the light source to function or operate properly. In such embodiments, one driver may supply suitable electric power to each light source. Alternatively, one dedicated driver can provide suitable electric power to the corresponding light source requiring the frequency-dependent electric power and a second independent driver can supply electric power to the remaining light source or light sources.

For example, in one preferred embodiment of this invention, second tube 36 defines second gas storage chamber 38 containing a supply of xenon gas, which may require electric power at a suitable or determined frequency in order to ionize the xenon gas to produce light. First tube 26 defines first gas storage chamber 28 containing a supply of neon gas, which may not require electric power supplied at a suitable or determined frequency or frequency range to ionize the neon gas and produce light. In one preferred embodiment of this invention, one power source, such as driver 50 or 55, can be connected to each light source to supply electric power at a suitable frequency required by second light source 30 containing xenon gas to produce light. Alternatively, a dedicated power source, such as driver 55, may supply electric power at a suitable frequency to second light source 30 containing the xenon gas, and an independent power source, such as driver 50, may supply electric power to first light source 20 containing the neon gas.

Thus, lamp 10 preferably but not necessarily includes independent drivers for providing or supplying electric energy or power to a corresponding light source. Referring to FIG. 2, first driver 50, such as a transformer, provides electrical energy to first light source 20. First driver 50 supplies power to electrodes positioned at each of positive contact 23 and negative contact 25. When power is supplied to positive contact 23 and negative contact 25, the first gas stored or contained within first gas chamber 28 ionizes, which produces for the first light source a distinctive glow. Similarly, second driver 55, such as an independent transformer, provides electrical energy or power to second light source 30. Second driver 55 supplies power to electrodes positioned at each of first positive contact 33 and second positive contact 35. When power is supplied to positive contacts 33, 35, the second gas stored or contained within second gas chamber 38 ionizes, which produces for the second light source a distinctive glow.

While in the foregoing specification this invention has been described in relation to certain preferred embodiments, and many details have been set forth for the purpose of illustration, it will be apparent to those skilled in the art that the invention is susceptible to additional embodiments, and that certain of the details described can be varied considerably without departing from the basic principles of the invention.

What is claimed is:

1. A lamp comprising:
a base;
a first light source including a first tube forming a first gas storage chamber containing a supply of a first gas;
a second light source including a second tube forming a second gas storage chamber containing a supply of a second gas, the first light source electrically connectable to the second light source and when electrically connected each of the first gas and the second gas electrically actuatable to produce light, and with the first light source electrically disconnected from the second light source the first gas at a static state.

2. The lamp of claim 1 wherein a base portion of the first light source is electrically connected to a base portion of the second light source.

3. The lamp of claim 1 wherein a lead wire electrically connects the first light source and the second light source.

4. The lamp of claim 3 wherein, with the lead wire disconnected from the first light source, the second gas is electrically actuatable to produce light and the first gas is at a static state.

5. The lamp of claim 1 wherein the first gas comprises neon gas and the second gas comprises xenon gas.

6. The lamp of claim 1 further comprising a power source supplying electric power to each of the first light source and the second light source.

7. The lamp of claim 6 wherein the power source supplies electric power at a determined frequency.

8. The lamp of claim 1 further comprising a dedicated driver supplying electric power to the second light source.

9. The lamp of claim 8 wherein the dedicated driver supplies electric power to the second light source at a determined frequency.

10. The lamp of claim 8 further comprising a second driver supplying electric power to the first light source.

11. The lamp of claim 1 wherein the first light source has a positive contact and a negative contact, and the second light source has a first positive contact and a second positive contact, and the positive contact of the first light source is normally electrically connected to the first positive contact of the second light source.

12. The lamp of claim 11 wherein, with the positive contact of the first light source disconnected from the first positive contact of the second light source, the first gas is at a static state and the second gas is electrically actuatable to produce light.

13. The lamp of claim 1 wherein a first base portion of the first tube forms the negative contact and a second base portion of the second tube forms the second positive contact of the second tube, and the negative contact is electrically connected to the second positive contact.

14. A lamp comprising:
a base;
a first light source having a positive contact and a negative contact, and a first tube forming a first gas storage chamber containing a supply of a first gas;
a second light source having a first positive contact and a second positive contact, and a second tube forming a second gas storage chamber containing a supply of a second gas, the positive contact of the first light source normally electrically connected to the first positive contact of the second light source and each of the first gas and the second gas energizable to produce light; and
a lead wire normally electrically connecting the positive contact of the first light source to the first positive contact of the second light source, and each of the first gas and the second gas energizable to produce light, and with the lead wire disconnected from the first light source the second gas energizable to produce light and the first gas at a static state.

15. The lamp of claim 14 wherein a base portion of the first light source forms the negative contact and a base portion of the second light source forms the second positive contact of the second light source, and the negative contact is electrically connected to the second positive contact of the second light source.

16. The lamp of claim 14 wherein the first gas comprises neon gas and the second gas comprises xenon gas.

17. The lamp of claim 14 wherein each of the first gas and the second gas is selected from the group consisting of neon, argon, xenon, krypton and combinations thereof.

18. The lamp of claim 14 further comprising:
a first driver supplying electrical energy to the first light source at a first frequency; and
a second driver supplying electrical energy to the second light source at a second frequency.

19. The lamp of claim 18 wherein at least one of the first driver and the second driver supplies power to a corresponding light source at a determined frequency.

20. A lamp comprising:
a base;
a first light source forming a first gas storage chamber containing a supply of neon gas electrically actuatable to produce light;
a first driver supplying electric energy to the first light source;
a second light source forming a second gas storage chamber containing a supply of xenon gas electrically actuatable to produce light; and
a second driver supplying electric energy to the second light source at a determined frequency.
